(19) United States
(12) Patent Application Publication
(10) Pub. No.: US 2010/0156821 A1
(43) Pub. Date: Jun. 24, 2010

(54) ELECTRONIC DEVICE AND METHOD FOR DETECTING MOVING DIRECTION OF INPUTS

(75) Inventor: JR-FU JUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/535,772

(22) Filed: Aug. 5, 2009

(30) Foreign Application Priority Data
Dec. 24, 2008 (CN) 200810306506.X

(51) Int. Cl. G06F 3/041

(52) U.S. Cl. 345/173

(57) ABSTRACT

An electronic device includes an input apparatus and a processor. The input apparatus includes a plurality of infrared ray (IR) modules, and each of the plurality of IR modules generates a pulse signal when activated by a user input. The processor includes a plurality of interrupt pins, and each of the plurality of interrupt pins is connected to one of the plurality of IR modules to receive a corresponding pulse signal from the one of the plurality of IR modules and to generate a corresponding interrupt signal. The processor determines if the input is a sliding input and a moving direction of the sliding input according to the interrupt signals generated by the plurality of interrupt pins.

### BACKGROUND

1. Technical Field

The disclosure relates to electronic devices, and particularly to an electronic device with an input apparatus and method for detecting moving direction of inputs.

2. Description of Related Art

Electronic devices with a display screen, such as handheld devices, may not be able to display an entire image due to limited size of the display screen. Thus, scrolling may be needed in order to view the entire image. In order to scroll through the image, a key must be pressed for many seconds to trigger a scrolling function. However, this method is slow and inefficient.

Some electronic devices are incorporated with a scrolling key to execute the scrolling function, which occupies more space and increases costs thereof. Some electronic devices are incorporated with a touch panel to detect a moving direction of a finger of a user to execute the scrolling function, which often requires use of high-cost chipsets to implement.

### BRIEF DESCRIPTION OF THE DRAWINGS

FIG. 1 is a schematic diagram of a first embodiment of an electronic device as disclosed.

FIG. 2 is a schematic diagram illustrating pulse signals generated by infrared ray modules of the electronic device of FIG. 1.

FIG. 3 is a schematic diagram of a second embodiment of an electronic device as disclosed.

FIG. 4 is a flowchart illustrating a first embodiment of a method for detecting moving direction of inputs as disclosed.

FIG. 5 is a flowchart illustrating a second embodiment of a method for detecting moving direction of inputs as disclosed.

### DETAILED DESCRIPTION

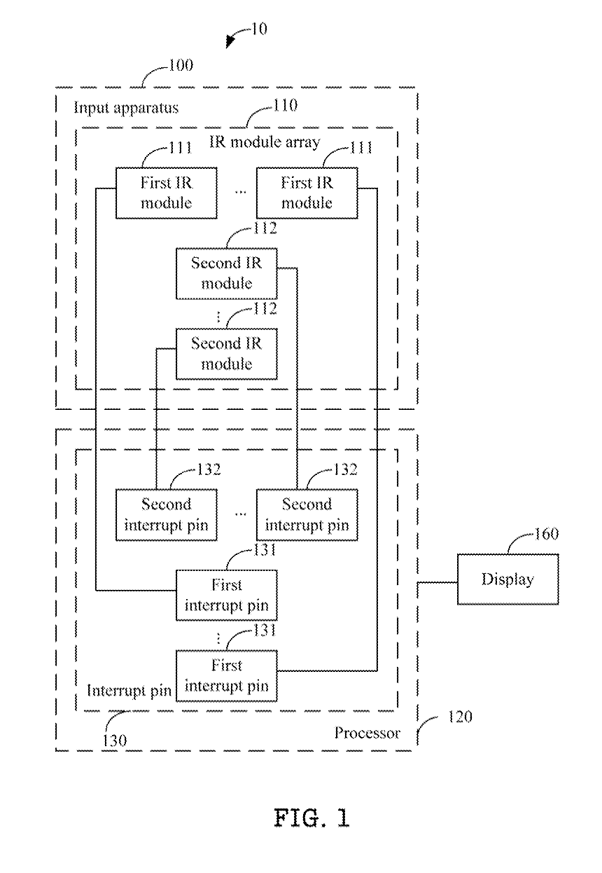

FIG. 1 is a schematic diagram of a first embodiment of an electronic device 10 as disclosed. The electronic device 10 includes an input apparatus 100 and a processor 120. The input apparatus 100 is used to receive an input of a user, such as a press input and/or a sliding input, and includes an infrared ray (IR) module array 110. The IR module array 110 includes a plurality of IR modules, where each of the plurality of IR modules generates a pulse signal when activated by the input of the user. In one embodiment, the sliding input may be defined as a finger depressing on or sliding above two or more IR modules in a series succession. When a finger of the user presses and/or slides on or above the plurality of IR modules, the plurality of IR modules receive IR reflected by the finger of the user, which turns on transistors in the plurality of IR modules to output the pulse signals. In one embodiment, the electronic device 10 may be a mobile communication device displaying images on a display 160 thereof, such as a mobile phone, a personal digital assistant, or a computer. In one embodiment, the input apparatus 100 may be a keypad, mouse, or a touch screen.

The processor 120 includes a plurality of interrupt pins 130. Each of the plurality of the interrupt pins 130 is connected to one of the plurality of IR modules, to receive a corresponding pulse signal from the one of the plurality of IR modules, and to generate a corresponding interrupt signal. The processor 120 determines if the input is a sliding input and a moving direction of the sliding input on the input apparatus 100 according to the interrupt signals generated by the plurality of interrupt pins 130. The processor 120 further controls a displayed image on the display 160 of the electronic device 10 to scroll according to the moving direction of the sliding input.

The IR module array 110 includes a plurality of first IR modules 111 and a plurality of second IR modules 112, where the plurality of first IR modules 111 and second IR modules 112 are arranged in different directions. For example, as shown in FIG. 1, the plurality of first IR modules 111 are arranged in a horizontal direction, and the plurality of second IR modules 112 are arranged in a vertical direction. It may be understood that the arranged directions of the IR module array 110 is exemplary and may include other directions depending on the embodiment.

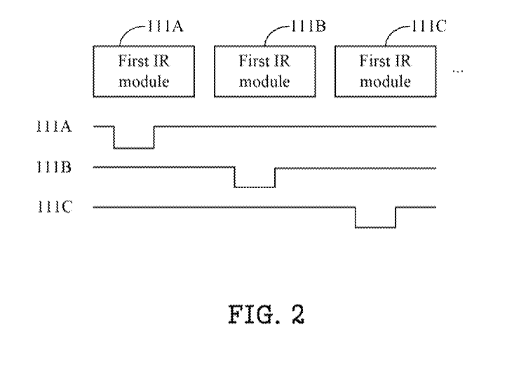

FIG. 2 is a schematic diagram illustrating pulse signals generated by the plurality of first IR modules 111. When a sliding input is in a horizontal direction, the plurality of first IR modules 111 continuously generate pulse signals. Because the sliding input activates the plurality of first IR modules 111 in a triggered order, each of the plurality of first IR modules 111 generates pulse signals according to the triggered order. For example, as shown in FIG. 2, a plurality of first IR modules 111A, 111B, and 11C are arranged in the horizontal direction from left to right. If the sliding input is in the horizontal direction from left to right, the plurality of first IR modules 111A, 111B, and 111C generate pulse signals continuously. That is, the first IR module 111A first generates a pulse signal, then the first IR module 111B generates a pulse signal, and the first IR module 111C finally generates a pulse signal. Thus, an order of the pulse signals indicates a moving direction of the sliding input.

The plurality of interrupt pins 130 include a plurality of first interrupt pins 131 and a plurality of second interrupt pins 132. Each of the plurality of first interrupt pins 131 is connected to one of the plurality of first IR modules 111, and each of the plurality of second interrupt pins 132 is connected to one of the plurality of second IR modules 112. Because the plurality of first IR modules 111 and second IR modules 112 continuously generate the pulse signals in the triggered order, the plurality of first interrupt pins 131 and second interrupt pins 132 also continuously generate the interrupt signals in the triggered order. Thus, the processor 120 determines if the input is the sliding input and the moving direction of the sliding input according to if the plurality of first interrupt pins 131 or the plurality of second interrupt pins 132 generates the interrupt signals continuously and an order of continuous interrupt signals.

The processor 120 determines the input is the sliding input if the plurality of interrupt pins generate the interrupt signals continuously, if a continuous count exceeds a predetermined count, and if an interval between the continuous interrupt signals is less than a predetermined time. If the interrupt signals are generated discontinuously, if the continuous count is less than the predetermined count, or if the interval between the continuous interrupt signals is greater than the predetermined time, the input is a press input. For example, if the input apparatus 100 is a keypad, the press input is a key press input, such as key presses for a dialing operation. In one embodiment, the interval between the continuous interrupt signals may be intervals between every neighboring interrupt signal or an interval among all the continuous interrupt signals, and the predetermined time may be different in the two conditions.

The electronic device 10 detects a moving direction of sliding inputs using the plurality of IR modules, which has reduced cost, can be implemented easily, and bring good performance to the user.

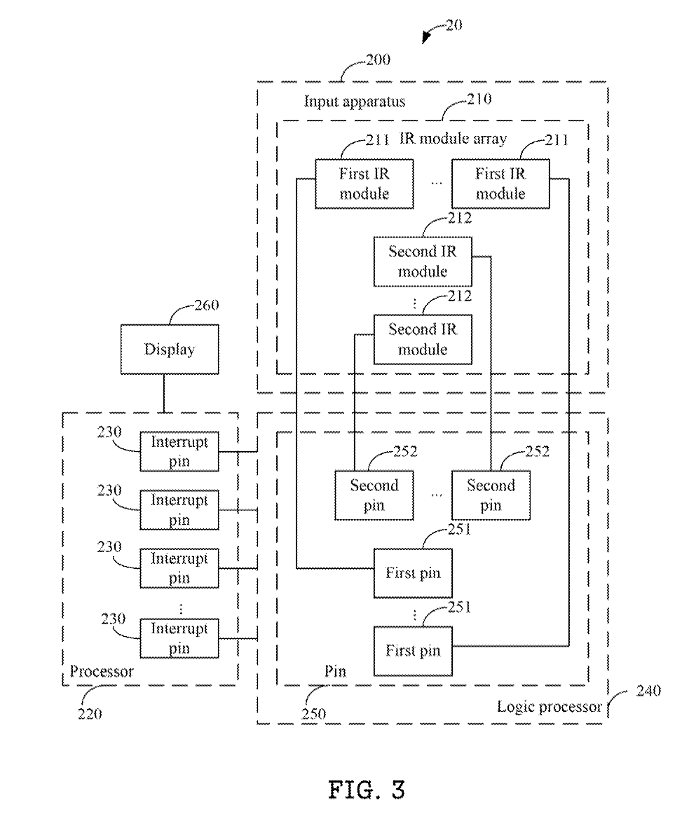

FIG. 3 is a schematic diagram of a second embodiment of an electronic device 20 as disclosed. The electronic device 20 includes an input apparatus 200, a logic processor 240 and a processor 220. The input apparatus 200 is used to receive an input of a user, such as a press input and/or a sliding input, and includes an IR module array 210. The function and structure of the IR module array 210 are similar to those of the IR module array 110 in FIG. 1, therefore, descriptions are omitted. In one embodiment, the electronic device 20 may be a mobile communication device displaying images on a display 260 thereof, such as a mobile phone, a personal digital assistant, or a computer.

The logic processor 240 includes a plurality of pins 250. Each of the plurality of pins 250 is connected to one of the plurality of IR modules to receive a corresponding pulse signal from the one of the plurality of IR modules. The logic processor 240 determines if the input is a sliding input and a moving direction of the sliding input according to the pulse signals and generates a corresponding direction indication signal.

The processor 220 includes a plurality of interrupt pins 230 to receive the corresponding direction indication signal from the logic processor 240 and to generate an interrupt signal. The processor 220 determines the moving direction of the sliding input according to an interrupt pin that generates the interrupt signal. In one embodiment, the plurality of interrupt pins 230 represent different directions. The processor 220 further controls a displayed image on the display 260 of the electronic device 20 to scroll according to the moving direction of the sliding input.

The plurality of pins 250 include a plurality of first pins 251 and a plurality of second pins 252. Each of the plurality of first pins 251 is connected to one of a plurality of first IR modules 211 of the IR module array 210, and each of the plurality of second pins 252 is connected to one of a plurality of second IR modules 212 of the IR module array 210. Because the plurality of first IR modules 211 and second IR modules 212 continuously generate the pulse signals in a triggered order, the plurality of first pins 251 and second pins 252 also continuously receive the pulse signals in the triggered order. Thus, the logic processor 240 determines the moving direction of the sliding input according to an order of continuous pulse signals, and generates and sends a corresponding direction indication signal, for example, a right direction indication signal to a right direction interrupt pin of the processor 220 to signal the processor 220 of the moving direction of the sliding input. In one embodiment, a format of the direction indication signal can be variable, and can make the corresponding interrupt pin 230 of the processor 220 generates an interrupt signal.

In one embodiment, the logic processor 240 determines the input is a sliding input if the pulse signals are generated continuously, if a continuous count exceeds a predetermined count, and if an interval between the continuous pulse signals is less than a predetermined time. If the pulse signals are generated discontinuously, if the continuous count is less than the predetermined count, or if the interval between the continuous pulse signals is greater than the predetermined time, the logic processor 240 determines the input is a press input, and signals the processor 220 to process the press input. For example, if the input apparatus 200 is a keypad, the press input is a key press input, such as key presses for a dialing operation. In one embodiment, the interval between the continuous pulse signals may be intervals between every neighboring pulse signal or an interval among all the continuous pulse signals, and the predetermined time may be different in the two conditions.

The electronic device 20 uses the logic processor 240 to first determine moving directions of sliding inputs, which reduces amounts of interrupt pins of the processor 220 and results in quick determination of the moving directions of the sliding inputs of the processor 220.

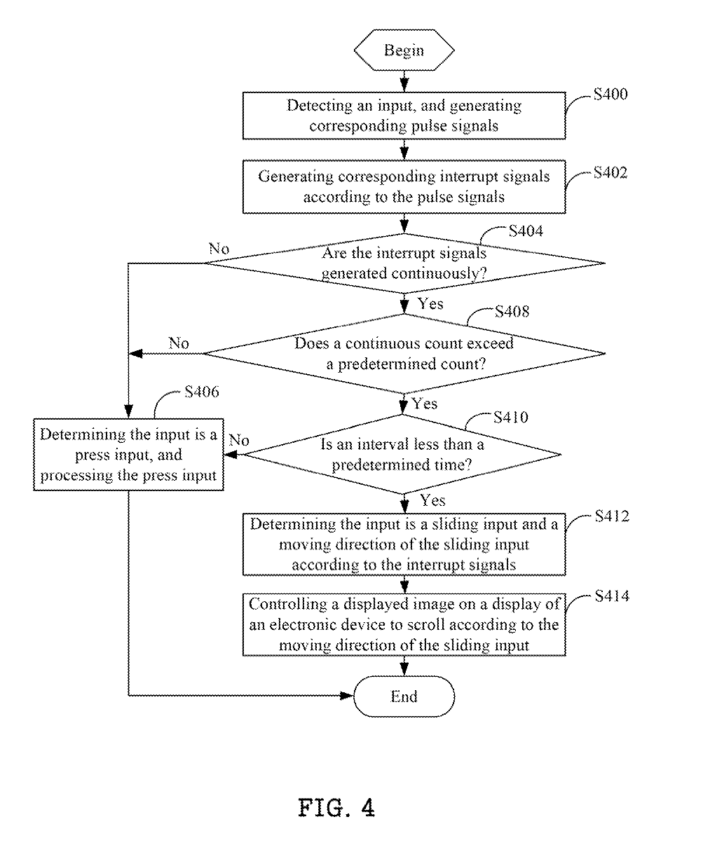

FIG. 4 is a flowchart of a first embodiment of a method for detecting moving direction of inputs as disclosed. In block S400, the plurality of IR modules detects an input of a user on the input apparatus 100, and generates corresponding pulse signals. In block S402, the plurality of interrupt pins 130 receive the pulse signals, and generate corresponding interrupt signals according to the pulse signals. In block S404, the processor 120 determines if the interrupt signals are generated continuously. If the interrupt signals are generated discontinuously, in block S406, the processor 120 determines the input is a press input, and processes the press input.

If the interrupt signals are generated continuously, in block S408, the processor 120 determines if a continuous count of the interrupt signals exceeds a predetermined count. If the continuous count is less than the predetermined count, block S406 is repeated.

If the continuous count exceeds the predetermined count, in block S410, the processor 120 determines if an interval between the continuous interrupt signals is less than a predetermined time. If the interval between the continuous interrupt signals is greater than the predetermined time, the process goes to block S406.

If the interval between the continuous interrupt signals is less than the predetermined time, in block S412, the processor 120 determines the input is a sliding input, and determines a moving direction of the sliding input on the input apparatus 100 according to the interrupt signals. In one embodiment, the processor 120 determines the moving direction of the sliding input according to an order of the continuous interrupt signals. In block S414, the processor 120 controls a displayed image on the display 160 of the electronic device 10 to scroll according to the moving direction of the sliding input.

In one embodiment, sequences of blocks S408 and S410 may be changed.

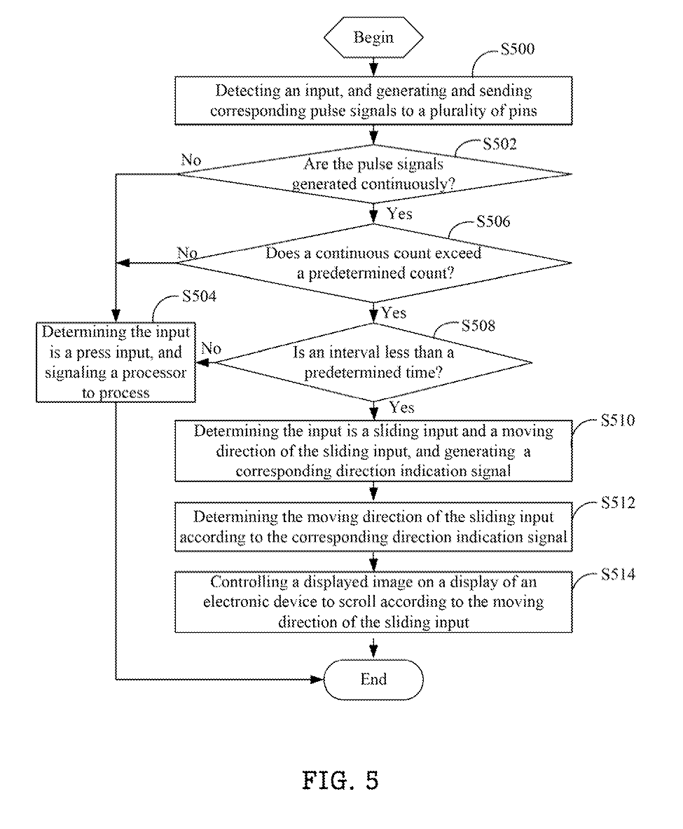

FIG. 5 is a flowchart of a second embodiment of a method for detecting moving direction of inputs as disclosed. In block S500, the plurality of IR modules detects an input of a user on the input apparatus 200, and generates and sends corresponding pulse signals to the plurality of pins 250. In block S502, the logic processor 240 determines if the pulse signals are generated continuously. If the pulse signals are generated discontinuously, in block S504, the logic processor 240 determines the input is a press input, and signals the processor 220 to process the press input.

If the pulse signals are generated continuously, in block S506, the logic processor 240 determines if a continuous count of the pulse signals exceeds a predetermined count. If the continuous count is less than the predetermined count, the process goes to block S504.

If the continuous count exceeds the predetermined count, in block S508, the logic processor 240 determines if an interval between the continuous pulse signals is less than a predetermined time. If the interval between the continuous pulse signals is greater than the predetermined time, the process goes to block S504.

If the interval between the continuous pulse signals is less than the predetermined time, in block S510, the logic processor 240 determines the input is a sliding input, determines a moving direction of the sliding input on the input apparatus 200 according to the pulse signals, and generates a corresponding direction indication signal. In one embodiment, the logic processor 240 determines the moving direction of the sliding input according to an order of the continuous pulse signals.

In block S512, the processor 220 determines the moving direction of the sliding input on the input apparatus 200 according to the corresponding direction indication signal. In one embodiment, one of the plurality of interrupt pins 230 receives the corresponding direction indication signal, and generates an interrupt signal. Then the processor 220 determines the moving direction of the sliding input according to the interrupt pin 230 that generates the interrupt signal. In block S514, the processor 220 controls a displayed image on the display 260 of the electronic device 20 to scroll according to the moving direction of the sliding input.

In one embodiment, sequences of blocks S506 and S508 may be changed.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. An electronic device, comprising:
an input apparatus comprising a plurality of infrared ray (IR) modules, wherein each of the plurality of IR modules generates a pulse signal when activated by a user input, the user input comprising a press input and a sliding input;
a processor comprising a plurality of interrupt pins, wherein each of the plurality of interrupt pins is connected to one of the plurality of IR modules, and receives a corresponding pulse signal from the one of the plurality of IR modules and generates a corresponding interrupt signal;
wherein the processor determines if the input is a sliding input and a moving direction of the sliding input according to the interrupt signals generated by the plurality of interrupt pins.

2. The electronic device of claim 1, wherein the plurality of IR modules comprise a plurality of first IR modules and a plurality of second IR modules, the plurality of first IR modules and second IR modules being arranged in different directions on the plurality of IR modules.

3. The electronic device of claim 2, wherein the plurality of interrupt pins comprise a plurality of first interrupt pins and a plurality of second interrupt pins, the plurality of first interrupt pins are respectively connected to the plurality of first IR modules, and the plurality of second interrupt pins are respectively connected to the plurality of second IR modules.

4. The electronic device of claim 3, wherein the processor determines the moving direction of the sliding input according to an order of continuous interrupt signals generated by the plurality of interrupt pins.

5. The electronic device of claim 4, wherein the processor determines the input is the sliding input if the plurality of interrupt pins generate the interrupt signals continuously, if a continuous count exceeds a predetermined count, and if an interval between the continuous interrupt signals is less than a predetermined time.

6. The electronic device of claim 5, wherein the processor determines the input is the press input if the plurality of interrupt pins generate the interrupt signals discontinuously, if the continuous count is less than the predetermined count, or if the interval between the continuous interrupt signals is greater than the predetermined time.

7. An electronic device, comprising:
an input apparatus comprising a plurality of infrared ray (IR) modules, wherein each of the plurality of IR modules generates a pulse signal when activated by a user input, the user input comprising a press input and a sliding input;
a logic processor comprising a plurality of pins, wherein each of the plurality of pins is connected to one of the plurality of IR modules to receive a corresponding pulse signal therefrom, wherein the logic processor determines if the input is a sliding input and a moving direction of the sliding input according to the pulse signals and generates a corresponding direction indication signal;
a processor comprising a plurality of interrupt pins to receive the corresponding direction indication signal from the logic processor and to generate an interrupt signal, wherein the processor determines the moving direction of the sliding input according to an interrupt pin that generates the interrupt signal.

8. The electronic device of claim 7, wherein the plurality of IR modules comprise a plurality of first IR modules and a plurality of second IR modules being arranged in different directions on the plurality of IR modules.

9. The electronic device of claim 8, wherein the plurality of pins of the logic processor comprise a plurality of first pins and a plurality of second pins, the plurality of first pins are respectively connected to the plurality of first IR modules, and the plurality of second pins are respectively connected to the plurality of second IR modules.

10. The electronic device of claim 9, wherein the logic processor determines the moving direction of the sliding input according to an order of continuous pulse signals.

11. The electronic device of claim 10, wherein the logic processor determines the input is a the sliding input if the pulse signals are generated continuously, if a continuous count exceeds a predetermined count, and if an interval between the continuous pulse signals is less than a predetermined time.

12. The electronic device of claim 11, wherein the logic processor determines the input is the press input if the pulse signals are generated discontinuously, if the continuous count is less than the predetermined count, or if the interval between the continuous pulse signals is greater than the predetermined time.

13. A method for detecting moving direction of inputs, comprising:
providing an input apparatus comprising a plurality of infrared ray (IR) modules;
detecting an input on the input apparatus, and generating corresponding pulse signals;
generating corresponding interrupt signals according to the pulse signals;
determining if the input is a sliding input according to the interrupt signals; and
determining a moving direction of the sliding input on the input apparatus according to the interrupt signals.

14. The method for detecting moving direction of inputs of claim 13, wherein determining if the input is a sliding input according to the interrupt signals comprises:
determining if the interrupt signals are generated continuously;
determining if a continuous count of the interrupt signals exceeds a predetermined count upon the condition that the interrupt signals are generated continuously;
determining if an interval between the continuous interrupt signals is less than a predetermined time upon the condition that the continuous count of the interrupt signals exceeds the predetermined count; and
determining that the input is the sliding input upon the condition that the interval between the continuous interrupt signals is less than the predetermined time.

15. The method for detecting moving direction of inputs of claim 14, wherein determining a moving direction of the sliding input on the input apparatus according to the interrupt signals comprises:
determining the moving direction of the sliding input on the input apparatus according to an order of the continuous interrupt signals.

16. The method for detecting moving direction of inputs of claim 14, further comprising:
determining that the input is a press input, and processing the press input upon the condition that the interrupt signals are discontinuous, the continuous count of the interrupt signals is less than the predetermined count, or the interval between the continuous interrupt signals is greater than the predetermined time.

17. A method for detecting moving direction of inputs, comprising:
providing an input apparatus comprising a plurality of infrared ray (IR) modules;
detecting an input on the input apparatus, and generating corresponding pulse signals;
determining if the input is a sliding input according to the pulse signals; and
determining a moving direction of the sliding input on the input apparatus according to the pulse signals, and generating a corresponding direction indication signal; and
determining the moving direction of the sliding input on the input apparatus according to the corresponding direction indication signal.

18. The method for detecting moving direction of inputs of claim 17, wherein determining if the input is a sliding input according to the pulse signals comprises:
determining if the pulse signals are generated continuously;
determining if a continuous count of the pulse signals exceeds a predetermined count upon the condition that the pulse signals are generated continuously;
determining if an interval between the continuous pulse signals is less than a predetermined time upon the condition that the continuous count of the pulse signals exceeds the predetermined count; and
determining that the input is the sliding input upon the condition that the interval between the continuous pulse signals is less than the predetermined time.

19. The method for detecting moving direction of inputs of claim 18, wherein determining a moving direction of the sliding input on the input apparatus according to the pulse signals comprises:
determining the moving direction of the sliding input on the input apparatus according to an order of the continuous pulse signals.

20. The method for detecting moving direction of inputs of claim 18, further comprising:
determining that the input is a press input, and signaling a processor to process the press input upon the condition that the pulse signals are discontinuous, the continuous count of the pulse signals is less than the predetermined count, or the interval between the continuous pulse signals is greater than the predetermined time.
